(19) United States
(12) Patent Application Publication
(10) Pub. No.: US 2010/0301583 A1
(43) Pub. Date: Dec. 2, 2010

(54) BOAT ENGAGEMENT AND SUPPORT DEVICE

(76) Inventors: JEFFREY RICHMOND EASTWELL, Greenslopes (AU); Robert Gordon Shawyer, Maclean (AU)

Correspondence Address: ROGITZ & ASSOCIATES, 750 B STREET, SUITE 3120, SAN DIEGO, CA, 92101, US

(21) Appl. No.: 12/790,005

(22) Filed: May 28, 2010

(30) Foreign Application Priority Data
Jun. 1, 2009 (AU) 2009100525

(51) Int. Cl. B60P 3/10

(52) U.S. Cl. 280/414.2; 280/43.17

(57) ABSTRACT

A boat engagement and support device having a boat hull engagement assembly to engage the boat hull, a lever pivotally attached to the boat hull engagement assembly and at least one wheel associated with both the boat hull engagement assembly and the lever whereby rotation of the lever relative to the boat hull engagement assembly forces the at least one wheel to abut the ground surface and continued movement of the lever raises and lowers the boat hull engagement assembly.

This application claims priority from Australian patent application 2009100525 filed Jun. 1, 2009.

### FIELD OF THE INVENTION

The present invention relates generally to the field of trailers and the like for at least temporarily supporting a boat, particularly when launching and recovery of the boat.

### BACKGROUND ART

An excellent discussion of the state of the art in relation to boat trailers and their attendant problems is provided in Australian Patent No. 2006100327 and is reproduced as follows, verbatim.

“One of the problems of concern to small boat users or owners of smaller marine vessels such as jet skis or the like, is the parking of the automobile and trailer after the vessel is launched. This problem has become even more acute as the popularity of small boat ownership has increased and available parking space has not kept up with the demand. Further, there are many launching sites which do not even provide any parking facilities.

Some of the small boat users are forced to transport the small boat atop their automobile. This involves, of course, using some type of carry-all on top of the automobile to protect the finish of the automobile. The vast majority however, use trailers to transport their marine vessel.

Even where adequate facilities are provided for parking the automobile and the trailer, there are many occasions when, after the boat is launched, and the trailer is still attached to the car, the automobile has to be used. In that case, the driver of the automobile has to lug the long trailer around or disconnect the trailer and leave it at the launching site with all the bother and risk that entails.

Trailers for small boats, of course, have to be stored during off-season. At that time, the boat may be stored on a rack in a garage, for example, and then it is important to be able to store the trailer in the smallest possible space. To this end, there is, in the prior art, many collapsible and foldable boat trailers.

Some of the prior art boat trailers use telescoping or detachable parts, whereby the trailers can be stored in the smallest possible space. Others used hinged parts so that the trailers may be folded for storage. Other means for transporting boat, in the past, have included using the boat itself as a trailer. In such cases, wheels are attached to the small boat frame and some type of hinge arrangement is used to attach the wheeled boat to the automobile for transportation.

A further type of trailer has a carriage of sufficient width to cradle and support a boat extending thereunder, a pair of supporting wheels each pivotally mounted to said carriage for pivotal movement with respect to said carriage from a folded horizontal position adjacent the carriage to a vertical position and an elongate boom carried by said carriage for supporting the bow and stern of a boat from beneath the front and rear portion of said boom.

Another collapsible boat trailer comprises a rigid frame which includes a tubular cross member with a forward extending towing bar coupling structure fixedly connected centrally intermediate the ends thereof.

A wheel fork assembly extends downwardly from both ends of the cross member. The upper ends of the wheel fork assemblies are pivotally connected to the cross member with a hinge such that the fork assemblies may be pivoted inwardly upwardly to lie adjacent the cross member, for inoperable stowage.

As can be seen, foldable or collapsible boat trailers generally have pivotally mounted wheels associated with them. The pivoting nature of the wheels results in a larger than necessary space being used when the trailer is folded or collapsed. This may particularly be the case when the wheels are each associated with a wheel protecting flap or “mud guard” which must be spaced from the wheel to allow the wheel to properly rotate.

It can be seen that there is a need for a collapsible boat trailer allowing both the carriage of a boat or other marine vessel and still allowing folding or collapsing into a substantially smaller configuration for storage by removing the wheels.”

Conventional trailers therefore have a transversely extending support structure between the wheels located on either side of the trailer and beneath the boat hull in order that the boat hull is supported on the transversely extending support structure. The support structure not only increases the weight of the trailer but also defines it is shape and size.

In the present specification and claims (if any), the following terms are used:
CHINE—The junction of the side and bottom planking or the member backing this junction.
GUNWALE (GUNNEL)—the upper edge of the side of a boat.
STRAKES—Longitudinal members running fore and aft on the outside bottom of the hull.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a boat engagement and support device, which may at least partially overcome at least one of the above-mentioned disadvantages or provide the consumer with a useful or commercial choice.

With the foregoing in view, present principles one form, reside broadly in a boat engagement and support device having a boat hull engagement assembly to engage the boat hull, a lever pivotally attached to the boat hull engagement assembly and at least one wheel associated with both the boat hull engagement assembly and the lever whereby rotation of the lever relative to the boat hull engagement assembly forces the at least one wheel to abut the ground surface and continued movement of the lever raises and lowers the boat hull engagement assembly.

In an alternative embodiment, present principles reside in a portable trailer for a boat, the trailer including at least a pair of the boat hull engagement and support devices, each having a boat hull engagement assembly to engage the boat hull, a lever pivotally attached to the boat whole engagement assembly and at least one wheel associated with both the boat hull engagement assembly and the lever whereby rotation of the lever relative to the boat hull engagement assembly forces the at least one wheel to abut the ground surface and continued movement of the lever raises and lowers the boat hull engagement assembly.

The boat engagement and support device is preferably used to engage with a boat hull directly and to allow the boat to be lifted or be maintained clear of a ground surface, in order to allow movement of the boat without a conventional trailer with a chassis that fits completely beneath the boat.

The device will normally find use with smaller, lighter boats, normally trailer transported such as aluminium boats or “tinnies” but may be used with any boat, or any size if provided in sufficient size.

Normally, the boat engagement and support devices will typically be used in pairs, with one device located on either side of the boat hull. The devices will normally support the boat above the ground whilst allowing users to move the boat hull, normally during launching and retrieval of the boat from a body of water.

Each boat engagement and support device will normally have a boat hull engagement assembly to engage a boat hull. According to a particularly preferred embodiment, the engagement assembly will normally be a clamping assembly but may be configured differently such as an assembly which acts to suspend the boat from the engagement assembly.

In the preferred clamping assembly, there will normally be a lower clamping portion provided in order to engage a lower portion of a side wall or chine of the boat hull and preferably an upper clamping portion in order to engage an upper edge of the sidewall or gunwale of the boat hull.

Each of the clamping portions will typically have a partially C-shaped or U-shaped engagement portion.

Typically, the lower clamping portion will be located at a lower end of at least one shaped support rail. Typically, more than one shaped support rail will be provided, normally a pair of spaced apart support rails.

Each support rail will preferably be formed from a pair of portions which are angled relative to one another. Normally, the portions will be angled relative to one another at an obtuse angle which is typically close to 180°.

The upper portion of each support rail will typically be substantially parallel to the boat hull sidewall when the device is in use and the lower portion of each support rail will typically be substantially parallel to a lower portion of the boat hull.

There will typically be a lower connection portion connecting the preferred pair of spaced apart support rails to one another. According to a particularly preferred embodiment, the respective upper ends of the support rails will typically be connected together as well.

The support rails may have any cross-sectional shape and be manufactured from any material but will typically be manufactured from a box metal section.

The upper clamping portion will preferably be provided on a movable arm in order to allow use of the device with boats of different dimensions. Preferably, the arm is provided pivotally in association with the support rails.

Preferably, the upper clamping portion will be provided on an assembly mounted to move the upper clamping portion relative to the support rails.

Preferably, the arm and also the upper clamping portion, will be mounted to the support rails, between the rails.

Preferably, a pair of spaced apart handle arms with a transverse mount between the handle arms is provided, to mount the arm and thereby the upper clamping portion, relative to the spaced apart support rails. Preferably, the mount attaches of the arm to which the upper clamping portion is mounted relative to the handle arms and thereby relative to the support rails. The arm is preferably pivotally mounted relative to the handle arms and the handle arms are preferably pivotally mounted to the support rails.

Typically, the arm will be movable relative to the mount in order to change the effective length of the arm and thereby the position of the upper clamping portion relative to the lower clamping portion, or the separation therebetween.

The handle arms are preferably pivotally attached to the support rails such that when pivoted in a first direction, the upper clamping portion moves away from the lower clamping portion and vice versa.

Typically, the handle arms may be provided in an over centre arrangement allowing locking of the handle arms relative to the support rails in order to fix the separation of the upper clamping portion relative to the lower clamping portion.

The pivoting action of the handle arms may move the upper clamping portion laterally (as in towards and away from the support rails) as well as towards and away from the lower clamping portion.

The handle arms are preferably formed from a pair of portions which are angled relative to one another typically through an obtuse angle. The handle arms are preferably located relative to the support arms such that the angle of the handle arms faces in the opposite direction to the angle between the support rail portions.

The arm will preferably be threaded externally and the mount provided with an internally threaded opening in order to adjust the effective length of the arm.

The boat engagement and support device will also preferably be provided with a lever pivotally attached to the boat engagement assembly. Normally, the lever will be attached pivotally to the lower connection portion between the spaced apart support rails. Typically, the lever will be elongate in order to provide increased leverage.

The lever will typically be longer than the support rails.

Preferably, the lever will extend above the upper clamping portion and below the lower clamping portion when the lever is substantially parallel to the support rails (typically the use or engaged condition).

There will typically be an elongate rod or similar assembly extending substantially perpendicularly from the lower connection portion in order to attach the lever thereto. Normally, the elongate rod will extend through an opening provided in the lever and the lever will normally pivot about the rod on the opposite side of the support arms to the clamping portions.

Normally, there will be more length of the lever provided above the pivot rod than below, preferably in a ratio of approximately 3 to 1.

Preferably, movement of the lever will move the at least one wheel between the ground engagement position which will subsequently force the boat engagement assembly upwards (the engaged or use condition) and a free position in which the boat engagement assembly is lowered and in which the boat engagement assembly will typically be attached or engaged with the boat hull in order to temporarily attach the device to the boat hull.

Suitable means will preferably be provided to temporarily fix or secure the lever relative to the boat engagement assembly when the lever and device is in the use condition.

Normally, the device will be attached to a boat hull when the boat is on a more permanent trailer, or alternatively, when it is desired to move the device. The handle arms will normally be pivoted upwardly in order to spread the respective clamping portions which are then located relative to a boat hull and the handle arms closed again in order to clamp the boat hull between the respective clamping portions. The lever will be normally be pivoted in order to engage the at least one wheel against a ground surface and further rotation of the lever will typically act to lift the boat engagement assembly above the wheel. When a boat engagement and support device is attached relative to either side of a boat hull, and the wheel moved to the use position, a person will typically be able to lift the front of the boat hull and move the boat.

When the boat is in the desired position, the lever may be actuated in order to move the wheel to the disengaged position and the clamping portion disengaged from the boat hull in order to release the boat hull.

Of course, more complex arrangements may be provided in order to raise and lower the boat engagement assembly relative to the wheel or to move the wheel between the use condition in which it abuts the ground surface and forces the boat engagement assembly upwards, and a free condition in which the boat hull can race against another object or surface. For example, the simplest mechanism is one in which the at least one wheel is attached directly to a lower end or portion of the lever arm and rotation of the lever arm moves the wheel directly.

However, other indirect mechanisms such as a jack mechanism may be provided wherein reciprocation of a lever arm forces the at least one wheel downwardly to above the ground surface and force be boat engagement assembly upwardly and the wheel can be released in order to move the wheel back towards the upper clamping portion.

In an alternative suspension embodiment, the boat engagement and support assembly may simply engage with the gunwale to support the boat. The assembly may simply be an arm or clamp to abut or grip the gunwale to engage the boat and hold or suspend the boat during movement.

### BRIEF DESCRIPTION OF THE DRAWINGS

Various embodiments of the invention will be described with reference to the following drawings, in which:

FIG. 1 is an isometric view from the rear of a boat engagement and support device according to a preferred embodiment of the present invention.

FIG. 2 is a perspective view from the side of the boat engagement and support device illustrated in FIG. 1.

FIG. 3 is a perspective view from the front of the boat engagement and support device illustrated in FIG. 1.

FIG. 4 is a front view of the boat engagement and support device illustrated in FIG. 1 in an engaged condition.

FIG. 5 is a front view of the boat engagement and support device illustrated in FIG. 1 in a partially engaged condition.

FIG. 6 is a front view of the boat engagement and support device illustrated in FIG. 1 in a disengaged condition.

FIG. 7 is an isometric view from the rear of a boat engagement and support device according to another preferred embodiment of the present invention.

FIG. 8 is a perspective view from the side of the boat engagement and support device illustrated in FIG. 7.

FIG. 9 is a perspective view from the front of the boat engagement and support device illustrated in FIG. 1,

FIG. 10 is a front view of the boat engagement and support device illustrated in FIG. 1 in an engaged condition.

FIG. 11 is a front view of the boat engagement and support device illustrated in FIG. 1 in a partially engaged condition.

FIG. 12 is a front view of the boat engagement and support device illustrated in FIG. 1 in a disengaged condition.

### DETAILED DESCRIPTION OF THE PREFERRED EMBODIMENT

According to a particularly preferred embodiment, a boat engagement and support device 10 is provided.

The boat engagement and support device 10 illustrated in the Figures has a boat hull engagement assembly 11 to engage the boat hull (not shown), a lever 12 pivotally attached to the boat hull engagement assembly 11 and a wheel 13 associated with both the boat hull engagement assembly 11 and the lever 12 whereby rotation of the lever 12 relative to the boat hull engagement assembly 11 forces the wheel 13 to abut the ground surface 14 and continued movement of the lever 12 raises and lowers the boat hull engagement assembly 11.

The boat engagement and support device 10 as illustrated is used to engage with a boat hull directly and to allow the boat hull to be lifted from the ground 14 or be maintained clear of a ground surface 14 in order to allow movement of the boat without a conventional trailer with a chassis that fits completely beneath the boat.

Normally, two boat engagement and support devices 10 will be used with one device located on either side of the boat hull. The devices will normally support the boat above the ground whilst allowing users to move the boat hull particularly, during launching and retrieval of the boat from a body of water.

According to the preferred embodiment illustrated, the engagement assembly 11 is a clamping assembly. In the preferred clamping assembly, a lower clamping portion 15 is provided in order to engage a lower portion of a side wall or more preferably, a chine on one side of the boat hull and an upper clamping portion 16 in order to engage an upper edge of the sidewall or gunwale on the same side of the boat hull.

Each of the clamping portions 15, 16 are configured as a partially C-shaped or U-shaped engagement portion.

As illustrated, the lower clamping portion 15 is located at a lower end of a pair of shaped support rails 17. The support rails 17 are spaced apart.

Each support rail 17 has a pair of portions, namely an upper and a lower portion which are angled relative to one another. As illustrated, the upper 18 and lower 19 portions are angled relative to one another at an obtuse angle which is typically close to 180°.

The upper portion 18 of each support rail 17 will be substantially parallel to the boat hull sidewall when the device is in use and the lower portion 19 of each support rail 17 will be substantially parallel to a lower portion of the boat hull.

A lower connection portion 20 is provided connecting the pair of spaced apart support rails 17 to one another. The respective upper ends of the support rails 17 may be connected together as well using a member extending about the upper ends.

The support rails 17 of the illustrated embodiment are manufactured from a box metal section.

The upper clamping portion 16 of the illustrated embodiment is provided on a movable arm 22 in order to allow use of the device 10 with boats of different dimensions. The arm 22 is provided pivotally in association with the support rails 17.

The arm 22 and also the upper clamping portion 16, are mounted to the support rails 17, between the rails 17.

A pair of spaced apart handle arms 23 with a transverse mount 24 between the handle arms 23 is provided to mount the arm 22 and thereby the upper clamping portion 16 relative to the spaced apart support rails 17. Preferably, the mount 24 attaches the arm 22 to which the upper clamping portion 16 is mounted, relative to the handle arms 23 and thereby relative to the support rails 17. The arm 22 is pivotally mounted relative to the handle arms 23 and the handle arms 23 are pivotally mounted to the support rails 17.

The arm 22 is movable relative to the mount 24 in order to change the effective length of the arm 22 and thereby the position of the upper clamping portion 16 relative to the lower clamping portion 15 or the separation therebetween.

The handle arms 23 are pivotally attached to the support rails 17 such that when pivoted in a first direction, the upper clamping portion 16 moves away from the lower clamping portion 15 and vice versa.

The handle arms 23 of the illustrated embodiment are provided in an over centre arrangement allowing locking of the handle arms 23 relative to the support rails 17 in order to fix the separation of the upper clamping portion 16 relative to the lower clamping portion 15.

The pivoting action of the handle arms 23 moves the upper clamping portion 16 laterally (as in towards and away from the support rails 17) as well as towards and away from the lower clamping portion 15.

The handle arms 23 of the illustrated embodiment are formed from a pair of portions which are angled relative to one another typically through an obtuse angle. The handle arms 23 are located relative to the support arms such that the angle of the handle arms 23 faces in the opposite direction to the angle between the support rails 17.

The lever 12 of the illustrated embodiment is attached pivotally to the lower connection portion 20 between the spaced apart support rails 17.

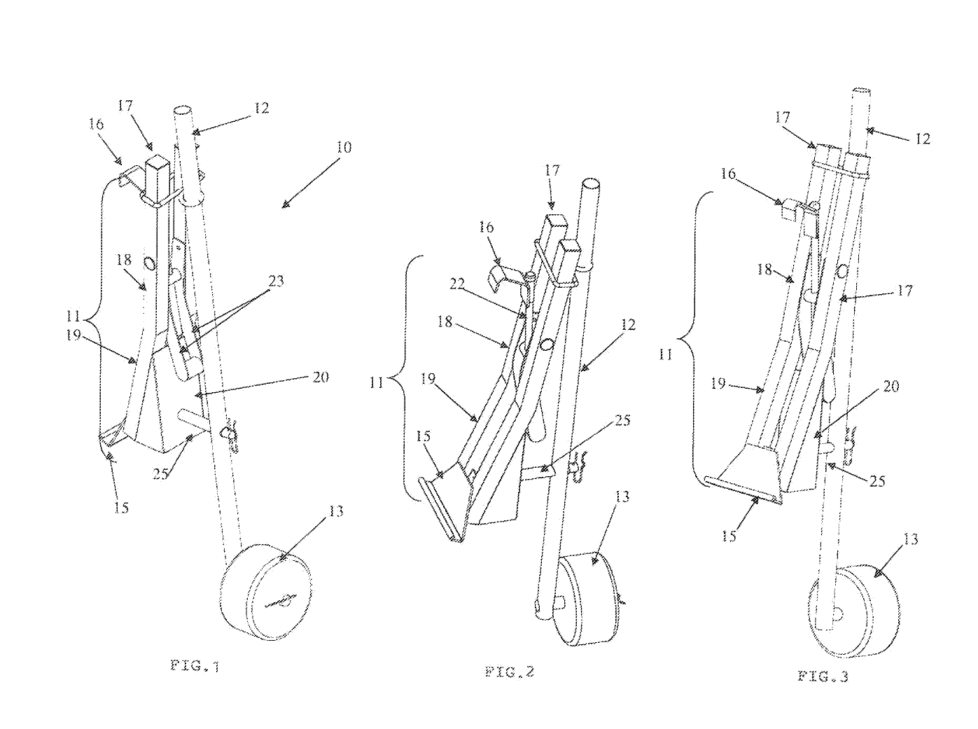

As illustrated in FIGS. 1-3 particularly, the lever 12 extends above the upper clamping portion 16 and below the lower clamping portion 15 when the lever 12 is substantially parallel to the support rails 17 (typically the use or engaged condition).

An elongate rod 25 extends substantially perpendicularly from the lower connection portion 20 in order to attach the lever 12 thereto. The elongate rod 25 extends through an opening provided in the lever 12 and the lever 12 pivots about the rod 25.

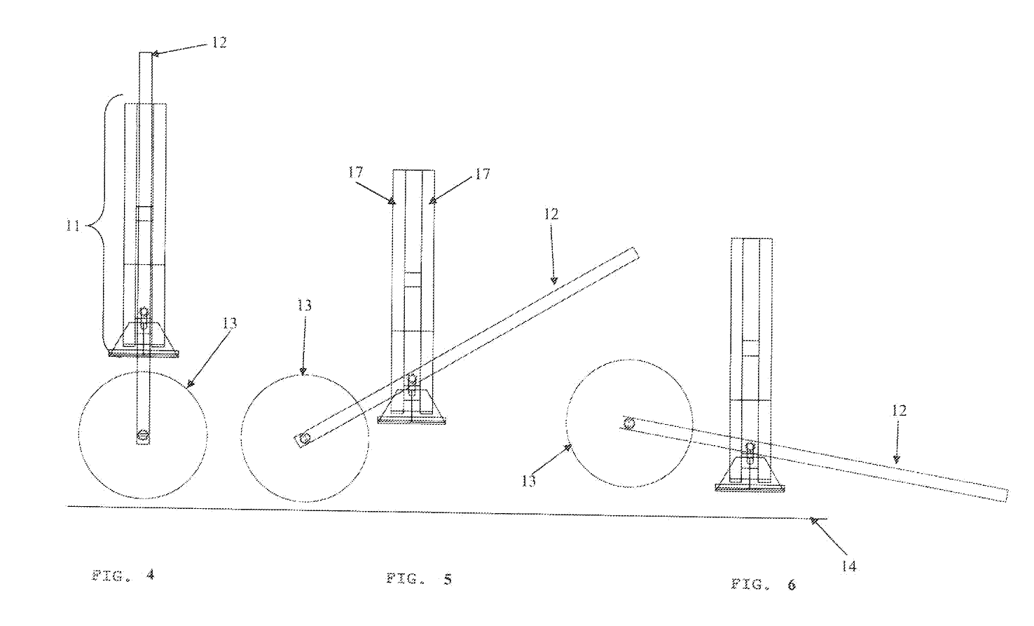

In use, movement of the lever 12 moves the wheel 13 between the ground engagement position (illustrated in FIG. 5) which will subsequently force the boat engagement assembly upwards (the engaged or use condition illustrated in FIG. 4) and a free position in which the boat engagement assembly is lowered illustrated in FIG. 6. The boat engagement assembly may be attached or engaged with the boat hull in order to temporarily attach the device to the boat hull in any or all of these conditions.

Normally, the device 10 will be attached to a boat hull when the boat is on a more permanent trailer or alternatively when it is desired to move the device. The handle arms 23 will normally be pivoted upwardly in order to spread the respective clamping portions 15, 16 which are then located relative to a boat hull and the handle arms 23 closed again in order to clamp the boat hull between the respective clamping portions 15, 16. The lever 12 will be normally be pivoted in order to engage the wheel 13 against a ground surface 14 and further rotation of the lever 12 will act to lift the boat engagement assembly 11 (with the boat secured thereto) above the wheel 13. When a boat engagement and support device 10 is attached relative to either side of a boat hull, and the wheel 13 moved to the use position, a person will typically be able to lift the front of the boat hull and move the boat.

When the boat is in the desired position, the lever 12 may be actuated in order to move the wheel 13 to the disengaged position and the clamping portions 15, 16 disengaged from the boat hull in order to release the boat hull.

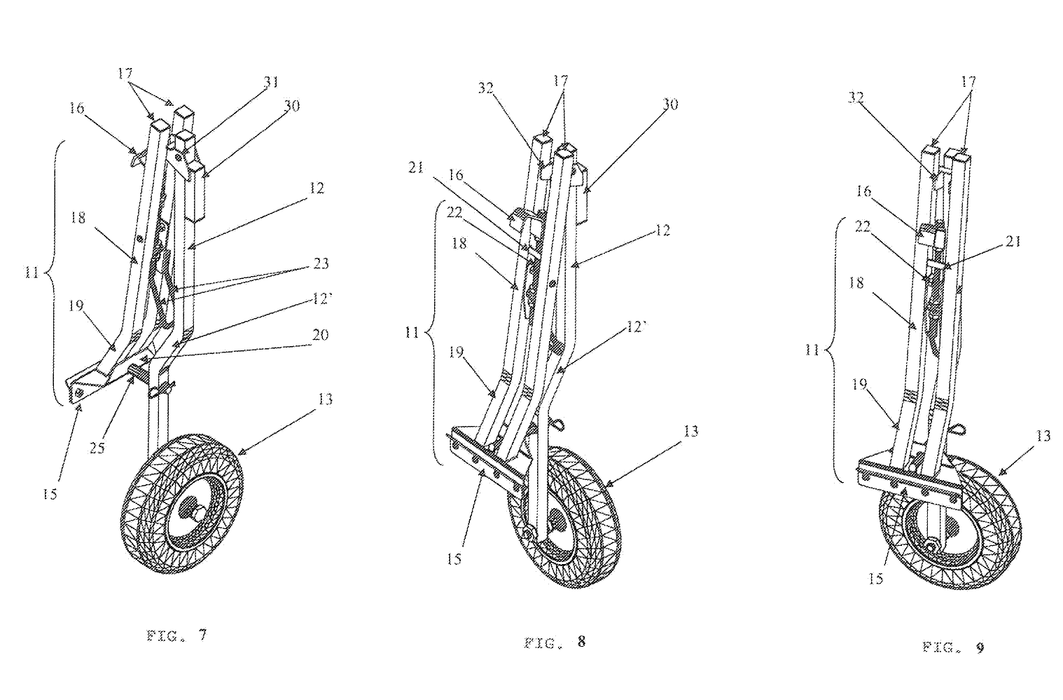

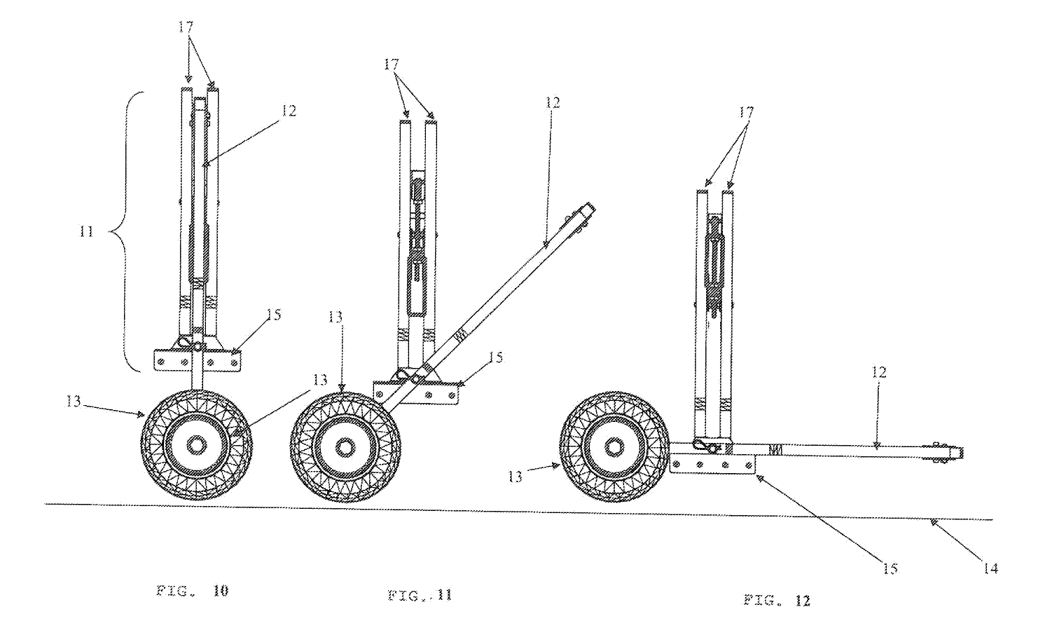

FIGS. 7 to 12 illustrate an embodiment similar to that illustrated in FIGS. 1 to 6. The embodiment in FIGS. 7 to 12 has a lever 12 with an angled portion 12′. The angled portion 12′ allows the wheel 13 to be located closer to the boat hull engagement assembly 11. In the embodiment illustrated in FIGS. 7 to 12, respective upper ends of the support rails 17 are connected together using a member 21 extending about the upper ends.

Furthermore, the embodiment in FIGS. 7 to 12 has a securing or latching assembly. The latching securing/assembly has a handle portion 30 and protrusions in the form of tab portions 32 pivotally connected at 31 to the lever 12. As illustrated in FIGS. 7 to 9, the tab portions 32 are received between the support rails 17, preventing the lever 12 from pivoting with respect to the boat hull engagement assembly 11. To pivot the lever 12 from the boat hull engagement assembly 11, the handle 30 of the latching assembly is raised, causing the tab portions 32 to withdraw from between the support rails 17 and therefore allowing the lever 12 to move therefrom.

In the present specification and claims (if any), the word “comprising” and its derivatives including “comprises” and “comprise” include each of the stated integers but does not exclude the inclusion of one or more further integers. Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A boat engagement and support device having a boat hull engagement assembly to engage a boat hull, a lever pivotally attached to the boat hull engagement assembly and at least one wheel associated with both the boat hull engagement assembly and the lever whereby rotation of the lever relative to the boat hull engagement assembly forces the at least one wheel to abut the ground surface and continued movement of the lever raises and lowers the boat hull engagement assembly.

2. A boat engagement and support device according to claim 1 wherein the boat hull engagement assembly is a clamping assembly.

3. A boat engagement and support device according to claim 2 wherein the clamping assembly includes a lower clamping portion provided in order to engage a lower portion of a side wall or chine of the boat hull and an upper clamping portion in order to engage an upper edge of the sidewall or gunwale of the boat hull.

4. A boat engagement and support device according to claim 3 wherein at least one of the clamping portions has a partially C-shaped or U-shaped engagement portion.

5. A boat engagement and support device according to claim 1, further comprising at least one support rail.

6. A boat engagement and support device according to claim 5 wherein the at least one support rail comprises a pair of spaced apart support rails.

7. A boat engagement and support device according to claim 2 wherein at least a portion of the clamping assembly is affixed to at least one support rail.

8. A boat engagement and support device according to claim 7 wherein a lower clamping portion is located at a lower end of the support rail(s).

9. A boat engagement and support device according to claim 5 wherein the at least one support rail has an angled portion.

10. A boat engagement and support device according to claim 9 wherein the angled portion is at an obtuse angle.

11. A boat engagement and support device according to claim 9 wherein the support rail is shaped to be substantially parallel to the boat hull in use.

12. A boat engagement and support device according to claim 1 wherein the lever has an angled portion.

13. A boat engagement and support device according claim 1, further including a securing assembly to secure the lever relative to the boat engagement assembly when the lever and device is in a use condition

14. A boat engagement and support device according to claim 13, wherein the securing assembly comprises a pivotable protrusion mounted on the lever, the protrusion being received by, or adjacent, at least one support rail to secure the lever relative thereto.

15. A boat engagement and support device according to claim 2 wherein at least a portion of the clamping assembly is movable to accommodate engagement of different sized boat hulls.

16. A boat engagement and support device according to claim 15 wherein an upper portion of the clamping assembly is mounted on a movable arm.

17. A boat engagement and support device according to claim 5, further comprising a pair of handle arms pivotably mounted relative to the at least one support rail, and a movable arm, with an upper clamping portion thereon, pivotably mounted relative to the handle arms.

18. A boat engagement and support device according to claim 1 wherein the lever is pivotably attached in a lower half of the lever.

19. A portable trailer for a boat, the trailer including at least a pair of boat hull engagement and support devices, each having a boat hull engagement assembly to engage the boat hull, a lever pivotally attached to the boat hull engagement assembly and at least one wheel associated with both the boat hull engagement assembly and the lever, whereby rotation of the lever relative to the boat hull engagement assembly forces the at least one wheel to abut the ground surface and continued movement of the lever raises and lowers the boat hull engagement assembly.

20. A portable trailer for a boat according to claim 19, wherein the boat hull engagement assembly is a clamping assembly.
